(19) United States
(12) Patent Application Publication
(10) Pub. No.: US 2010/0313498 A1
(43) Pub. Date: Dec. 16, 2010

(54) DECORATIVE MOLDING TRIMMING SYSTEM AND METHOD OF INSTALLING

(76) Inventors: Reza Paidar, Vaughn (CA); Davood Paydar, Vaughan (CA)

Correspondence Address: JOSEPH R. CARVALKO, JR., 50 BEACH AVENUE, MILFORD, CT, 06460, US

(21) Appl. No.: 12/781,847

(22) Filed: May 18, 2010

Related U.S. Application Data
(60) Provisional application No. 61/185,620, filed on Jun. 10, 2009.

(51) Int. Cl. E04F 13/073; E04B 1/38; E04C 2/20; F21V 19/00

(52) U.S. Cl. 52/173.1; 52/288.1; 52/745.21; 52/309.1

(57) ABSTRACT

This invention generally relates to a method and system for installing decorative moldings including a mounting block made of a soft and light material adapted to be secured to a wall and extended about a border thereof, said mounting block having a first contacting surface parallel to the wall and a second contacting surface oriented at an angle to a mounting surface of a crown molding, said first contacting surface having a parallel rigid member thereon for securing the mounting block to the wall and the second contacting surface having an angular oriented rigid member thereon for securing the decorative molding to the mounting block.

### CROSS-REFERENCE TO RELATED APPLICATIONS

This application claims the priority benefit under 35 U.S.C. 119 (e) of U.S. Provisional Application No. 61/185,620, Trim Molding and Method of Installing, filed on Jun. 10, 2009,the entire disclosure of which is hereby incorporated by reference herein.

### FIELD OF THE INVENTION

This invention generally relates to methods and systems in the field of ornamental decorative moldings such as crown moldings, and relates more particularly to elongated or molded/cast decorative molding strips having outer surfaces with decorative ornamentation and surfaces for engaging supporting walls usually the ceiling and a vertical wall of a room space, through an intermediary component.

### BACKGROUND OF THE INVENTION

Crown moldings cover and decorate the corner where room walls and ceilings meet. High speed wood molding machinery, modern extrusion techniques and casting technologies and materials have made it possible to produce large quantities of highly ornate crown molding quickly and economically. As a consequence, such trim has become extremely popular and is used in trimming out interior rooms of homes and other buildings as never before. Examples of such crown moldings are shown in U.S. Pat. Nos. 5,433,048, 5,662,753 and 5,398,469. These patents illustrate a variety of ways to design, manufacture and install crown moldings. The application of molding is usually time consuming and often requires a skilled carpenter to avoid visually unpleasing effects of poor installation. Additionally, products are designed and sold to minimize labor expenses through a consideration of types of materials used, material costs, shipping and handling costs, and the ease by which the molding is installed; and the means in which the molding is fastened.

Skilled labor is often required to install crown molding properly. As such, these installations tend to be expensive. Part of the reason skilled labor needs to be retained for crown molding installation has to do with the installation of the hardware needed to support the crown molding itself. Various systems have been developed from wood firing strips to metal hangars. However, these are too cumbersome to be applied by the average home owner or do-it-your-selfer. A need therefore exists for assemblies and methods that permit non skilled installation, while reducing installation time.

Additionally, most crown molding and associated wall mounting systems are designed to mount the crown molding flush with the ceiling and the wall completely enclosing the corner or intersection between the wall and the ceiling. Recently, occasionally architectural designers desire that the crown molding be displaced from the ceiling for among other reasons to install indirect lighting. The problems related to the conventional installation of crown molding as indicated above are therefore compounded when installing crown molding in areas where direct lighting is required.

In general then, a continuing and heretofore unaddressed need exists for a decorative molding trimming system that is reliable, firm, accurate, simple, quick, inexpensive, and easily to install, not only for the skilled craftsman but for the “do-it-your-selfer”, both for conventional installations and for installations requiring indirect lighting. It is an object of the present invention to provide for such a trimming system.

### SUMMARY OF THE INVENTION

This invention generally relates to methods and systems in the field of ornamental moldings, and relates more particularly to elongated or molded/cast crown molding strips having outer surfaces with decorative ornamentation and surfaces for engaging supporting walls usually a ceiling and a vertical wall of a room through an intermediary component. More particularly, the invention herein includes a decorative molding trimming system for applying molded trim about the periphery of a room including: a support adapted to be secured to the wall of a room and extending about a border thereof, said mounting block having a first contacting surface parallel to the wall and a second contacting surface oriented at an angle to a mounting surface of a crown molding, said first contacting surface having a parallel associated rigid member thereon for aiding in mounting the mounting block to the wall and the second contacting surface having a angular oriented associated rigid member thereon for aiding in attaching the crown molding to the support.

In another embodiment of the invention a decorative molding trimming system for installing a molded trim about the periphery of a room includes: a mounting block adapted to be secured to a wall of a room and extending about a border thereof, said mounting block having a first rigid member that provides a first contacting surface parallel to the wall and having a second rigid member that provides a second contacting surface oriented at an angle to a mounting surface of the molded trim, for aiding in securing the molded trim to the mounting block and to the wall.

The invention further includes associated rigid parallel members having material penetrable by a fastening device.

The invention further includes the decorative molding trimming system mounting block composed of a soft and light material such as but not limited to Expanded Poly Styrene (EPS) or a plastic material.

The invention further includes the parallel rigid member contacting the wall.

The invention herein further includes the parallel rigid member embedded in the mounting block support.

The invention herein further includes the angular oriented rigid member contacting the decorative molding.

The invention herein further includes the mounting block having a generally, but not limited to, triangular cross section.

The invention herein further includes the mounting block having a surface parallel with the ceiling.

The invention herein further includes the mounting block top surface for supporting a lighting system.

### BRIEF DESCRIPTION OF THE DRAWINGS

FIG. 1 is a perspective view of a decorative molding trimming system in accordance with an embodiment of the invention;

FIG. 2 is a plan view of a decorative molding trimming system in accordance with an embodiment of the invention;

FIG. 3a, b, c and d illustrate features of a decorative molding trimming system in accordance with various embodiments of the invention;

FIG. 4 is a plan view of a fully installed decorative molding trimming system in accordance with an embodiment of the invention.

FIG. 5 is an installation drawing showing the placement of a lighting strip in accordance with an embodiment of the invention;

FIG. 6 is an installation drawing showing the placement of a crown molding onto a mounting block support in accordance with an embodiment of the invention.

### DETAILED DESCRIPTION OF THE INVENTION

The following detailed description includes the best mode of carrying out the invention and is made for the purpose of illustrating the general principles of the invention and should not be taken in a limiting sense. The scope of the invention is determined by reference to the claims. Each part or function is assigned, even if structurally identical to another part, a unique reference number wherever that part is shown in the drawing figures.

The invention disclosed herein relates to a method and a system that allows for decorative molding trimming installation that is reliable, firm, accurate, simple, quick, inexpensive, and easy, not only for the skilled craftsman but for the “do-it-your-selfer”, for conventional installations and for installations requiring indirect lighting. Normally mechanical fasteners (such as nails or screws) cannot be used to attach light and soft material such as EPS to a wall. Also, nails and screws can not be used to attach other material (such as crown molding) to a soft and light material. Having strips of harder material (such as, but not limited to wood, MDF or plastic) inserted, embedded or attached to a mounting block support making it possible to use tools such as nail guns to attach the mounting block to the substrate, and attach other material such as a crown molding to the soft material. The mechanical fasteners can be used in combination with adhesives such as glues. The mechanical fastener will be driven through the soft and light material but will grip the harder strips and ultimately fasten to a wall. In addition, other components can be attached to the mounting by mechanical fasteners (glues can be used along with the mechanical fasteners). As will be described the invention makes attachment of a mounting block or support to a substrate (e.g. wall) easier and faster.

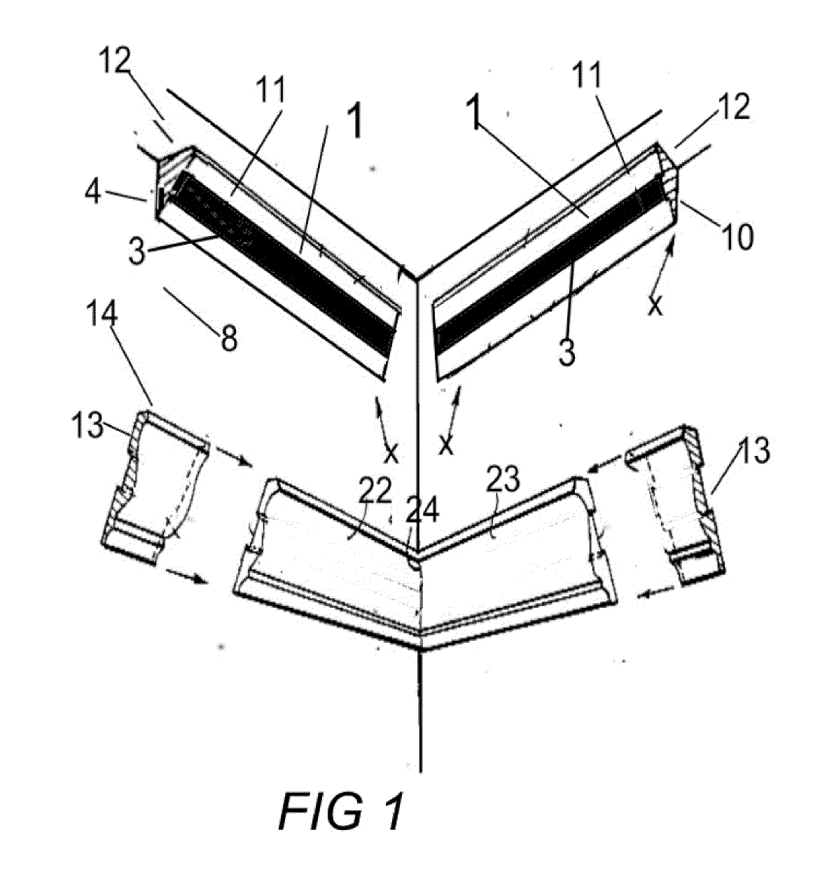

Referring to FIG. 1, a system for decoratively applying crown molded trim about the periphery of a room includes: a mounting block 1 is adapted to be secured to the wall 8 of a room and extending about a border thereof, said mounting block 1 having a first contacting surface 10 parallel to the wall 8 and a second contacting surface 11 oriented at an angle to a decorative accessory such as a crown molding 13, said first contacting surface 10 having a parallel associated rigid member 4 for aiding in mounting the mounting block 1 to the wall 8 and the second contacting surface having an angular oriented associated rigid member 3 for mounting the crown molding 13 to mounting block 1.

A prefabricated corner piece of crown molding 13 has left and right leg 22 and 23 respectively that extends at substantially right angles with respect to each other and that are securely joined together at the proper angled orientation by a mitered or coped joint 24. In this regard, it is preferred that the joint 24 be coped rather than simply mitered to provide some flexibility of adjustment of the corner piece without opening a significant gap at the joint 24. In this way, the corner piece can accommodate rooms that may not be perfectly square while preserving the crisp mitered-looking joint at the corner. In respect to FIG. 1 the crown molding 13 is moved into place over the mounting block 1 in the direction of the arrows X.

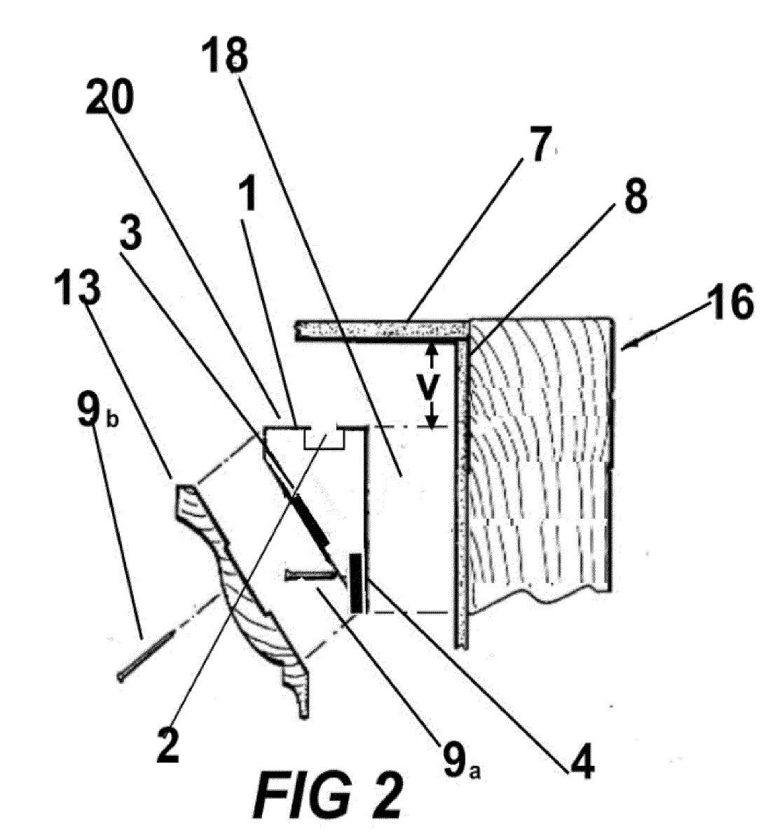

Turning attention to FIG. 2, in one embodiment of the invention mounting block 1 block is mounted on wall 8 in a position 18 such that a gap V between the mounting block 1 and ceiling 7 permits a lamp, strip of lights or lighting assembly 20 to be mounted into a cove or slot 2 to create indirect lighting above the crown molding 13 assembly. The mounting block 1 is permanently mounted on wall 8 through the utilization of support strip 4 and the application of fastener 9a that fastens the mounting block 1 to the wall 8 and its frame 16. The crown molding 13 is attached to the mounting block 1 through utilization of support strip 3 and the application of fastener 9b.

In one embodiment of the invention, the mounting block 1 is composed of a light material such as EPS, as the main body. Strips of material such as strip 3 and strip 4, are composed of wood or wood composition such as MDF or any material harder than mounting block 1 which allow for a stable and reliable anchor of the crown molding 13 to the mounting block 1 and a stable and reliable anchor of mounting block 1 to the wall 8 and the frame 16.

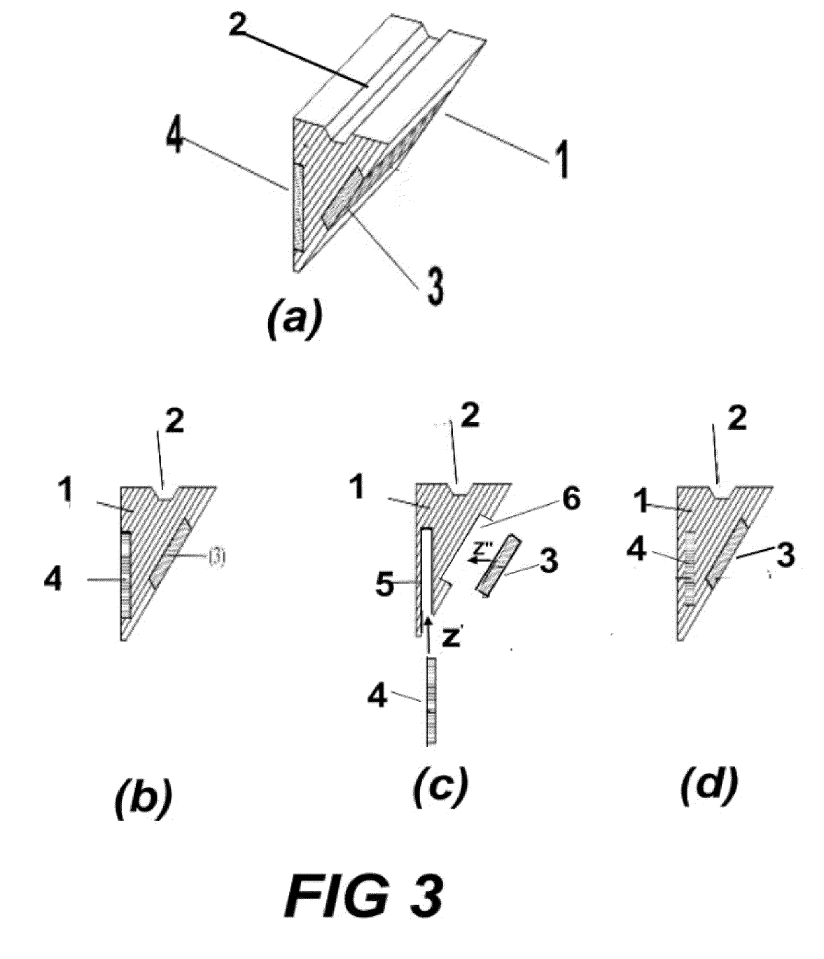

In FIG. 3a the mounting block 1 is shown in a perspective drawing wherein an optional channel 2 is used to house a light source. In this non limiting embodiment, a wedge shaped mounting block 1 is employed, however as will be apparent the shape of the mounting block 1 may be any shape that carries out the objects of the invention in supporting the crown molding 13 (FIG. 1).

In FIG. 3b, the strips 3, 4 of material harder than the mounting block 1 material are inserted into position so as to form an interfacing contact with the wall 8 (strip 4) and the crown molding 13 (strip 3). The incorporation of strips 3, 4 may be achieved by any method that achieves the objects set forth herein. As shown in FIG. 3c and FIG. 3d, the strip 4 is embedded into the softer and lighter body of the mounting block 1. For example, strip 3 and/or strip 4 as illustrated in FIG. 3a may take the form of a linear strip or belt of material (not shown). As more fully illustrated in FIG. 3c the strip 3 may snap Z″ into a track 6 which may be dovetailed as provided for in mounting block 1. Also as more fully illustrated in FIG. 3c strip 4 may fit Z′ into a slot or rectangular channel 5 or track. Strips 3, 4 may thereafter be reinforced or fastened through a process of heat or gluing. Likewise the strip 4 as embedded in FIG. 3c, and FIG. 3d, may be achieved through a process of insertion into channel 5 as described above or molded into a channel 5 during the process of fabricating the mounting block 1. Methods of integrating the strips 3, 4 into EPS or plastic support materials are well known by those individuals having ordinary skill in the art of fabricating molded products.

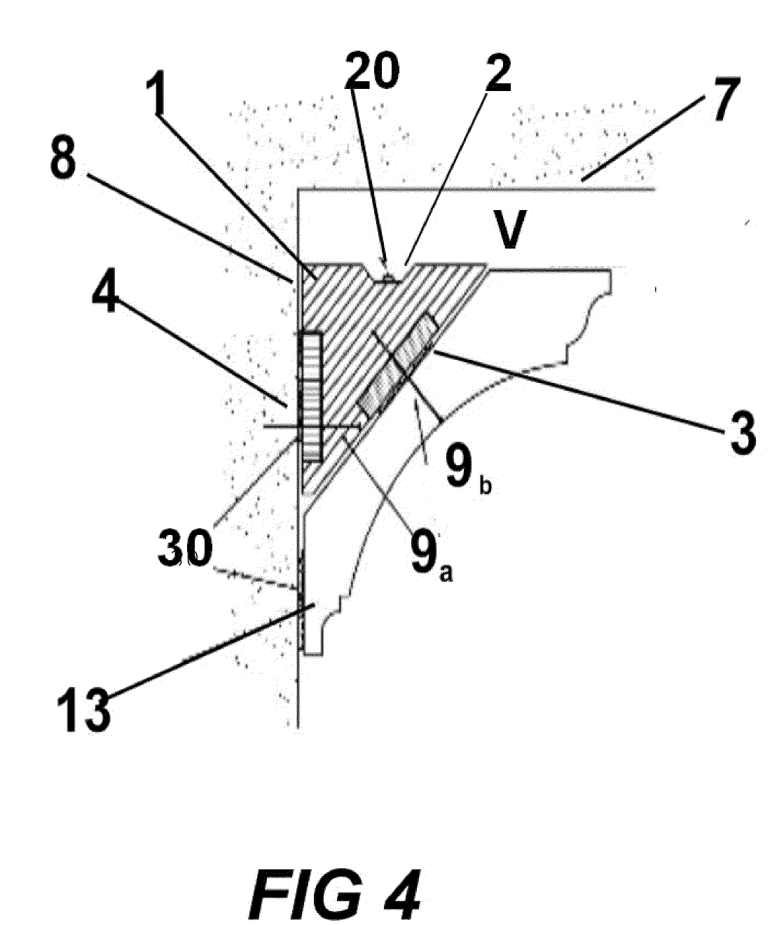

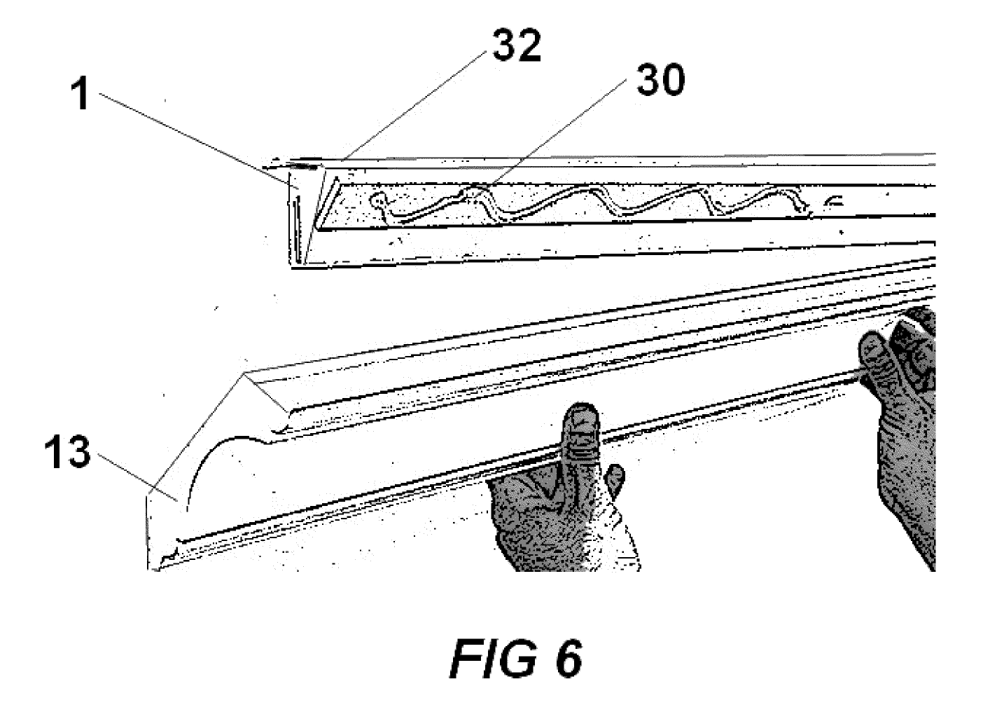

FIG. 4 illustrates one embodiment of a completed assembly. The mounting block 1 and the crown molding 13 may be further reinforced via and adhesive such as any bond or glue 30 (FIG. 4, and FIG. 6). In one method of installation the mounting block 1 having strips 3, 4 installed thereon is mounted on wall 8 using a glue and nailed through strip 4 using nail 9a to provide a fast and reliable attachment of the mounting block 1 to the wall. The attachment of the mounting block 1 to the wall will become firm and permanent when the glue cures. The crown molding 13 is then placed into position linearly having glue on its mounting block 1 interfacing surface including the surface that contacts wall 8. Thereafter crown molding 13 is nailed to strip 3. The optional light source 20 may be installed completing the installation.

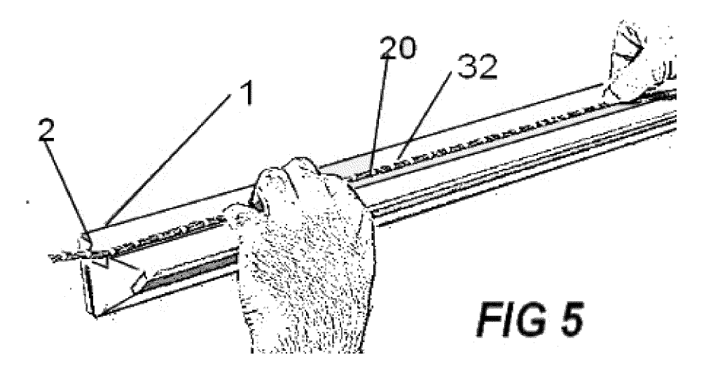

The installation in accordance with an embodiment of the invention is illustrated in FIGS. 4, 5, and 6. The method of installation may vary according to an installer's skill, but generally an installer may proceed as follows: Step 1, apply adhesive such as glue 30 to the back of the mounting block support 1 that will contact the wall 8. Step 2, place the mounting block support 1 on the wall 8. Nail through strip 4 using nail 9a to provide a fast and reliable attachment of the mounting block 1 to the wall 8 section on the face of the mounting block 1. The nail must go through foam and strip 4 on the back of the mounting block 1. Install the mounting block 1 all around the wall. Step 3, wire up the LED lighting 2 and test to insure it functions properly. Apply adhesive or glue 30 to the strip 3 facing the back of the crown molding 13. Step 6, install crown molding 13. Nail the crown molding 13 to the mounting block 1, strip 3.

While the foregoing invention has been described with reference to the above embodiments, additional modifications and changes can be made without departing from the spirit of the invention. Accordingly, such modifications and changes are considered to be within the scope of the appended claims.

We claim:

1. A decorative molding trimming system for installing a molded trim comprising: a mounting block adapted to be secured to a wall and extended about a border thereof, said mounting block having a first contacting surface parallel to the wall and a second contacting surface oriented at an angle to a mounting surface of a decorative molding, said first contacting surface having a parallel rigid member thereon for securing the mounting block to the wall and the second contacting surface having a rigid member thereon for securing the decorative molding to the mounting block.

2. The decorative molding trimming system in claim 1 wherein the mounting block serves to associate the decorative molding to the wall and to permit indirect lighting.

3. The decorative molding trimming system in claim 1 wherein the rigid members are used to anchor the mounting block to the wall and the molding to the mounting block and wherein each of said blocks are made of material penetrable by a fastening device.

4. The decorative molding trimming system in claim 1 wherein the mounting block is composed of a penetrable and lightweight material such as, but not limited to expanded polystyrene or a plastic material.

5. The decorative molding trimming system in claim 1 wherein the rigid member is bonded to the wall using one of a glue or one or more mechanical fasteners.

6. The decorative molding trimming system in claim 1 wherein the rigid members are embedded in the mounting block member.

7. The decorative molding trimming system in claim 1 wherein the associated rigid member contacts the decorative molding.

8. The decorative molding trimming system in claim 1 wherein the mounting block has any polygonal shaped cross section.

9. The decorative molding trimming system in claim 1 wherein the mounting block has a slot for mounting a strip of lights.

10. The decorative molding trimming system in claim 1 wherein the mounting block contains one or more slots for installing the associated rigid members.

11. The decorative molding trimming system in claim 1 wherein the mounting block top surface is spaced from the ceiling to support indirect lighting.

12. A method of installation for a decorative molding trimming system comprising:
applying a bond to a mounting block facing a wall; nailing the mounting block to the wall through the rigid member along the wall; installing one of (a) an LED or (b) rope lighting into the top surface of the mounting block; applying a bond to the mounting block and the rigid member facing the rear of a decorative molding; and
fastening the decorative molding to the mounting block through the rigid member facing the decorative molding.
